(19) United States
(12) Patent Application Publication
(10) Pub. No.: US 2023/0392221 A1
(43) Pub. Date: Dec. 7, 2023

(54) A NEW WEAR RESISTANT STEEL WITH HIGH HARDNESS AND GOOD TOUGHNESS WHICH KEEPS HARDENED AFTER HARD FACING AND TUNGSTEN CARBIDE TILE BRAZING

(71) Applicants: Shane Xinyang LI, Brisbane (AU); Yuankui TANG, Liaoning (CN)

(72) Inventor: Shane Xinyang LI, Brisbane (AU)

(21) Appl. No.: 18/032,001

(22) PCT Filed: Nov. 22, 2021
(86) PCT No.: PCT/AU2021/051387

§ 371 Date: Apr. 14, 2023

(30) Foreign Application Priority Data
Nov. 27, 2020 (AU) 2020904402

(51) Int. Cl. C21D 1/18; C22C 38/34; C22C 38/38; C22C 38/22; C22C 38/24; C21D 6/00

(52) U.S. Cl. CPC C21D 1/18; C22C 38/34; C22C 38/38; C22C 38/22; C22C 38/24; C21D 6/002; C21D 6/005; C21D 6/008

(57) ABSTRACT

The present invention relates to a steel composition consisting of Carbon (C) 0.15-1.50%, Silicon (Si) 0.9-3.5%, Manganese (Mn) 1.0-4.0%, Chromium (Cr) 0.6-5.0%, Molybdenum (Mo) 0.05-0.60%, Vanadium (V) 0.05-6.00%, Tungsten (W) 0.05-10.00%, the balance being Iron (Fe) and unavoidable impurities. The steel composition retains high hardness after hard facing and tungsten carbide tile brazing, allowing for application to farming and mining industries and the like.

### FIELD OF INVENTION

The present invention relates to a steel composition to retain high hardness after hard facing and tungsten carbide tile brazing and its application to farming and mining industries and the like.

### BACKGROUND OF INVENTION

It is a common practice in farming and mining industry to apply hard facing or tungsten carbide tile brazing onto the surface of hardened wear resistant steel parts to increase the service life. However, the heat from hard facing or brazing always results in over tempering or even annealing of hardened steel substrate, resulting in a very soft substrate covered by a hard case. The softened substrate is worn out much faster than a hard case in application, dramatically eliminating benefit from expensive hard facing and tungsten carbide tile brazing. For example, a planting point made of quench hardened 8630 steel with tungsten carbide tiles brazed is always worn out in a very short time with only minor or no visible wear loss on expensive tungsten tiles. Considering that the cost of tungsten carbide tiles can take up to 90% of the cost of a planting point, it is impractical to utilize tungsten carbide tile brazing.

### SUMMARY OF INVENTION

The present invention provides a steel composition comprising essentially of:
C Carbon: 0.15-1.50%; Si Silicon: 0.9-3.5%; Mn Manganese: 1.0-4.0%; Cr Chromium 0.6-5.0%; Mo Molybdenum 0.05-0.60%; V: Vanadium 0.05-6.00%; W Tungsten 0.05-10.00; B boron, S Sulphur and P in minute quantities, remainder substantially all iron.

Preferably, steel composition comprises carbon up to 1.40%.

Preferably, steel composition comprises silicon up to 3.00%.

Preferably, steel composition comprises molybdenum up to 0.5%.

Preferably, steel composition comprises vanadium up to 6.00%.

Preferably, steel composition comprises tungsten up to 9.00%.

Preferably, steel composition comprises carbon up to 1.5%, silicon 3.4%, tungsten 8.0% and vanadium 6.0%.

Preferably, steel composition comprises carbon 0.8%, silicon 3.5%, tungsten 6.0 and vanadium 6.0%.

Preferably, steel composition comprises carbon 1.5%, silicon 3.5%, tungsten 6.0% and vanadium 6.0%.

Preferably, steel composition comprises carbon 0.9%, silicon 3.3%, tungsten 2.0% and vanadium 6.0%.

Preferably, steel composition comprises carbon 0.2-0.3%, silicon 2.6-2.8%, manganese 2.0-2.3%, chromium 2.7-3.0%, molybdenum 0.15-0.25 and vanadium 0.40-0.70%.

Preferably, steel composition comprises carbon 0.3-0.4%, silicon 2.6-2.8%, manganese 2.0-3.0%, chromium 2.5-3.0%, molybdenum 0.3-0.5%, tungsten 6-8% and vanadium 0.20-0.40%.

In another aspect, the invention provides a wear resistant steel which remains hardened after hard facing or tungsten carbide tile brazing comprising essentially of:
C Carbon: 0.15-0.90%; Si Silicon: 0.9-3.5%; Mn Manganese: 1.0-4.0%; Cr Chromium 0.6-5.0%; Mo Molybdenum 0.15-0.60%; V: Vanadium 0.10-0.20%; B boron, S Sulphur and P in minute quantities, remainder substantially all iron.

In another aspect, the invention provides a wear resistant steel of high hardness and toughness which maintains high hardness after hard facing or tungsten carbide tile brazing comprising essentially of:
C Carbon: 0.15-1.50%; Si Silicon: 0.9-3.5%; Mn Manganese: 1.0-4.0%; Cr Chromium 0.6-5.0%; Mo Molybdenum 0.05-0.60%; V: Vanadium 0.05-6.00%; W Tungsten 0.05-10.00; B boron, S Sulphur and P in minute quantities, remainder substantially all iron.

Preferably, hardening temperature is in the range 820-980° C. and tempering temperature is in the range 150-550° C.

Preferably, the chemical content of Carbon is adjusted to ensure all materials are tempered at the same peak toughness temperature; there are two temperature zones and the toughness will drop to make steel softened and brittle instead of getting softened and tougher wherein tempering is avoided at those low toughness zone to enable good hardness/toughness combination.

Preferably, the resulting product remains hardened after hard facing and tungsten carbide tile braising.

In another aspect, the invention provides a method of treating a steel composition according to the present invention wherein hardness and strength is achieved by adjusting the composition to ensure that all steel is tempered at peak toughness temperature to achieve good combination of hardness, strength and good toughness.

Preferably, peak toughness is determined by measuring the degree of hardness and toughness at various tempering temperatures and identifying the first peak of toughness.

Preferably, the optimal hardness/toughness combination is determined by variations in carbon compositions while maintaining the same peak toughness temperature during the tempering process.

### BRIEF DESCRIPTION OF DRAWINGS

FIG. 1 shows the comparison of the tungsten carbide tile brazed planting points with the traditional quench hardened 8630 steel substrate and the steel substrate of the composition according to the present invention.

FIG. 2 shows the results of a field trial with 16 inch swipes made of steel composition according to the present invention

### DETAILED DESCRIPTION

A new steel composition according to the present invention retains high hardness after hard facing and tungsten carbide tile brazing. The field trial of tungsten carbide tile brazed planting points made of the steel substrate according to the present invention showed tremendous improvement over traditional quench hardened 8630 steel in the same highly abrasive soil on the same towing bar. The point with traditional 8630 steel substrate was worn out after about 150 acres, while the point with the new invented hard steel substrate has done 15000 acres (7000 acres is the result up to last year, now has done 15000 acres, i.e. used for 3 years and the point is still not yet worn out. Compared to having to replace point a few times during planting season and no replacing required for over 3 years, that is a big difference)_, and is still functioning.

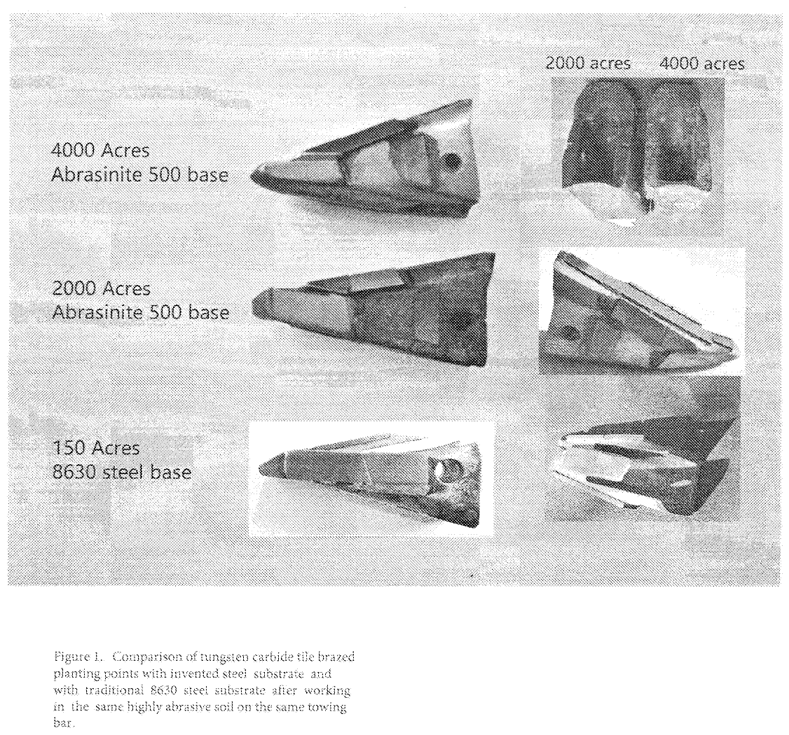

FIG. 1 shows the comparison of the tungsten carbide tile brazed planting points with this invented steel substrate and the traditional quench hardened 8630 steel substrate. The points that have done 15000 acres are not shown in FIG. 1 as they are still on the towing bar.

This invented steel can also be used without any hard facing or tungsten carbide tile brazing because of high hardness and good toughness. There have been quite a few successful applications of this invented steel without hard facing or carbide tile brazing.

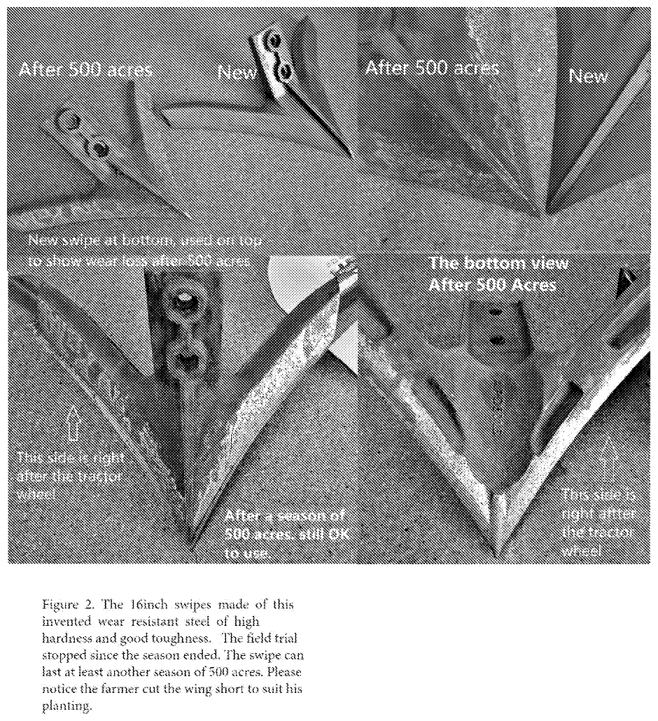

FIG. 2 shows the results of a field trial with 16 inch swipes made of this invented steel, with only minor wear loss after a season of 500 acres.

The chemical make-up of this invented steel shown in Table 1.

TABLE 1
Chemical make-up of the new invented steel

| | Element | | | | | | | | | |
|---|---|---|---|---|---|---|---|---|---|---|
| | C | Si | Mn | Cr | Mo | V | W | S | P | Fe |
| % | 0.10.-1.50 | 0.90-3.50 | 1.00-4.00 | 0.60-5.00 | 0.05-0.60 | 0.05-6.00 | 0.05-10.00 | ≤0.040 | ≤0.040 | rest |

The chemical make-up of this invented hard steel can be adjusted based on the chemical content shown in Table 1 to meet special requirements such as anti corrosion or working at elevated temperature.

This invented hard steel can keep very competitive low costs for general application by adjusting the chemical make-up within the chemical content shown in Table 1.

Table 2 shows the heat treatment parameters of this invented steel

TABLE 2
Heat treatment parameters of the invented steel

| Hardening | | | Tempering | | |
|---|---|---|---|---|---|
| Tempera- | | | Tempera- | | |
| ture | Holding | Cooling | ture | Holding | Cooling |
| (° C.) | time | Medium | (° C.) | time | Medium |
| 820-980 | 1.0 hour/25 | Oil or | 150-550 | 1.5 hour/25 | Oil or |
| | mm | Air | | mm | Air |

As described in Table 2, the final hardness and toughness are achieved by adjusting the chemical content to ensure tempering of the steel after quenching only at peak tempering temperature. This table shows even this casting steel made with scraps which is hard to control the element range and content, the steel has achieved very good hardness/toughness combination. If clean raw iron and alloy element are used, process to make this casting steel is improved, and the toughness of Abrasinite 500 can be achieved at over 32J at room temperature and over 28J at −40 degree C.

Table 3 shows the mechanical properties of this invented steel after heat treatment. All results are from casted steel samples.

This invented steel can be forged and rolled to improve the hardness/toughness combination.

TABLE 3
Mechanical properties of the invented
steel after heat treatment (as casted)

| | | | Toughness | Toughness | |
|---|---|---|---|---|---|
| | Tensile | Yield | (Charpy v- | (Charpy un- | Hard- |
| | Strength | Strength | notched) | notched) | ness |
| Serial ID | (MPa) | (MPa) | (J) | (J) | (HB) |
| Toughnite 400 | >1000 | >800 | >28 | | 380-420 |
| Abrasinite 450 | | | >23 | | 420-470 |
| Abrasinite 500 | | | >18 | | 470-520 |
| Abrasinite 550 | | | >13 | | 520-570 |
| Abrasinite 600 | | | >8 | | 560-610 |
| Abrasinite 600A | | | | >9 | 610-670 |

This unique invented wear resistant steel with high hardness and good toughness which keeps hardened after hard facing or tungsten carbide tile brazing will have wide applications in the farming and mining industry.

The steel composite according to the present invention provides high hardness after hard facing and tungsten carbide tile brazing. The field trial of tungsten carbide tile brazed planting points made of the steel composite substrate showed tremendous improvement over traditional quench hardened 8630 steel in the same highly abrasive soil on the same towing bar. The point with traditional 8630 steel substrate has been worn out after about 150 acres, while the point with new invented hard steel substrate has done 15000 acres and is still functioning.

This invented steel can also be used without any hard facing or tungsten carbide tile brazing because of the good hardness/toughness combination. There have been quite a few successful applications of this invented steel without hard facing or tungsten carbide tile brazing in farming industry.

The chemical make-up of this invented hard steel can be adjusted to meet special requirements such as anti-corrosion or working at an elevated temperature.

The hard steel composite according to the present invention provides a very competitive low cost product for general application by adjusting the chemical content as well.

The hardness and strength of the steel composite according to the present invention may be altered by adjusting content of some of alloy elements. Normally, steel is hardened, then tempered at different temperatures for different strength and hardness. The problem is when the hardened steel is tempered, toughness is not always increased with decreasing to hardness and strength because almost all steel have temperature range of tempering with toughness dropped dramatically, so sometimes toughness is compensated to achieve desired hardness. The hardness/strength according to the present invention is achieved by adjusting the chemicals to ensure that all steel is tempered at peak toughness temperature to achieve good combination of hardness/strength with good toughness.

Table 3 shows the mechanical property available from casting, which is good combination of hardness/strength with toughness.

TABLE 4
Chemical makeup of the invented steel

| Serial ID | C % | Si % | Mn % | Cr % | Mo % | V % | S % | P % |
|---|---|---|---|---|---|---|---|---|
| Toughnite 400 | 0.17-0.22 | 2.60-2.80 | 2.00-2.30 | 1.48-1.52 | 0.15-0.25 | | <0.040 | <0.030 |
| Abrasinite 450 | 0.20-0.25 | 2.60-2.80 | 2.00-2.30 | 1.48-1.52 | 0.15-0.25 | | <0.040 | <0.030 |
| Abrasinite 500 | 0.23-0.28 | 2.60-2.80 | 2.00-2.30 | 1.48-1.52 | 0.15-0.25 | | <0.040 | <0.030 |
| Abrasinite 550 | 0.27-0.31 | 2.60-2.80 | 2.00-2.30 | 1.48-1.52 | 0.15-0.25 | | <0.040 | <0.030 |
| Abrasinite 600 | 0.33-0.38 | 2.60-2.80 | 2.00-2.30 | 1.48-1.52 | 0.15-0.25 | | <0.040 | <0.030 |
| Abrasinite 600A | 0.75-0.83 | 1.40-1.60 | 2.00-2.30 | 1.48-3.80 | 0.20-0.55 | 0.15-0.20 | <0.040 | <0.030 |

Table 4 shows the chemical composition range for each element for each alloy type used in Table 3.

The real advantage of this material is it can keep hardened with hard facing and tungsten tile braising. Both processes need high temperature, for all steels/cast irons used so far, the base is always tempered to very low hardness and strength by heat of hard facing and tungsten carbide tile braising, resulting in a very soft core with hard shell. Once soft base diminishes, other parts also deteriorate.

Tables 5 and 6 exemplify the steel with two more new chemical compositions developed from original Abrasinite 500 and Abrasinite 550.

TABLE 5
The upgraded Abrasinite 550 steel for wear resistant parts used in Acidic Soil or Acidic slurry/gravels
Chemical make up of the steel

| C | Si | Mn | Cr | Mo | V | S | P |
|---|---|---|---|---|---|---|---|
| 0.27-0.31 | 2.60-2.80 | 2.00-2.30 | 2.70-3.00 | 0.15-0.25 | 0.40-0.70 | <0.040 | <0.030 |

Heat treatment for modified Abrasinite 550 for acidic soild/slurry

| Hardening | | | Tempering | | |
|---|---|---|---|---|---|
| Temperature | | Cooling | Temperature | | Cooling |
| (° C.) | Holding time | Medium | (° C.) | Holding time | Medium |
| 820-980 | 1.0 hour/25 mm | Oil or Air | 150-550 | 1.5 hour/25 mm | Oil or Air |

Mechanical property of Modified Abrasinite 550 for acidic soil/slurry

| | Tensile | Yield | Toughness | Toughness | |
|---|---|---|---|---|---|
| | Strength | Strength | (Charpy | (Charpy | Hardness |
| Serial ID | (MPa) | (MPa) | v-notched) (J) | un-notched) (J) | (HB) |
| Abrasinite 550 for | | | >13 | | 520-570 |
| acidic soil/slurry | | | | | |

The results in Table 5 indicate that need steel can be used in acidic conditions, particularly in mining industry. In mining areas the mine is usually acidic, hence some soil is acidic as well. This steel composition includes vanadium up to 0.4-0.7% and demonstrates improved rust resistant properties so steel composition will work well in an acidic environment.

TABLE 6
The upgraded Abrasinite 500 steel for wear/impact resistant parts used in High temperature (up to 700 degree C.)
Chemical make up of the steel

| C | Si | Mn | Cr | W | Mo | V | S | P |
|---|---|---|---|---|---|---|---|---|
| 0.31-0.39 | 2.60-2.80 | 2.00-2.30 | 2.50-3.00 | 6.00-8.00 | 0.30-0.50 | 0.20-0.40 | <0.030 | <0.030 |

Heat treatment for modified Abrasinite 500 for high temperature

| Hardening | | | Tempering | | |
|---|---|---|---|---|---|
| Temperature | | Cooling | Temperature | | Cooling |
| (° C.) | Holding time | Medium | (° C.) | Holding time | Medium |
| 1000-1200 | 1.0 hour/25 mm | Oil or Air | 150-550 | 1.5 hour/25 mm | Oil or Air |

Mechanical property of Modified Abrasinite 550 for high temperature

| | Tensile | Yield | Toughness | Toughness | |
|---|---|---|---|---|---|
| | Strength | Strength | (Charpy | (Charpy | Hardness |
| Serial ID | (MPa) | (MPa) | v-notched) (J) | un-notched) (J) | (HB) |
| Abrasinite 500 for | | | >16 | | 470-520 |
| high temperature | | | | | |

The updated Abrasinite 500 shown in Table 6 comprises 6-8% W, with V added for using at temperature up to 700º C. This steel can be used for underground drilling which can be pretty hot or used as forging die.

The steel composite according to the present invention remains hardened after hard facing and tungsten carbide tile braising, i.e. hard core remains, resulting in increased service life of wear resistant material from 10-100 times. This is the most unique feature of the invention achieved so far.

To get the steel quench hardened, the steel is heated to above A3 temperature, i.e., to make sure all microstructure of the steel Austenitized and kept at the Austenitized temperature for certain time according to the thickness of the steel part, then cooled to room temperature by quenching the steel in oil or in air. Then the resulting product is tempered to eliminate the residual stress from cooling and stabilize the structure.

Different from traditional heat treatment, the expected hardness of the steel is not achieved by tempering at different temperature, but tempered at the peak toughness temperature only and by adjusting the chemical content to get different hardness of the steel, to achieve best hardness/toughness combination.

The steel can be cooled either in oil or air after tempering. The hardenable steel need to quench in water or oil to get hardened, then need tempering to stabilize microstructure to make sure no deformation or cracking during application, to achieve desired hardness. So tempering is very important after quench hardening.

The steel composite according to the present invention is designed to use less expensive alloy element and small amount of expensive alloy element to decrease the cost (price of alloy element such as Ni, Cr, Mo has increased substantially in last decades) and to maintain at least the same quality of the traditionally used wear resistant material such as Cr27 (with 27% Cr), avoided using Ni, only small amount of Cr and Mo, V is not expensive, Mn and Si are cheaper than Fe, P and S are unavoidable impurities which must be lower than amount showing in the Table.

The steel composite according to the present invention provides excellent properties such as hardness about HRC52-53 while keeping toughness over 30J (about 28J tested at −40 degree C.). However, for most of the farm consumables, cost is the problem. Hence, most of the steel products according to the present invention are made of scraps and very hard to control the impurities (some alloy elements bring in from scarp is also impurities since they are not wanted). The mechanical properties showing on the patent application is based on castings from scraps, which is quite good already.

The advantage of this material is not only wear resistant and low cost, most importantly, it remains hardened after tungsten carbide braising and tungsten particles hard facing, enabling the tile braised and hard faced wear resistant parts to extend service life from a few times to 100 times. To maintain hardness after braising and hard facing is a unique property of the present invention.

According to the present invention, to maintain good toughness, the chemical content (mostly Carbon) is adjusted to make sure all materials are tempered at the same peak toughness temperature (traditionally the steel is quench hardened, then tempering at different temperature to achieve the desired hardness/strength. However, there are two temperature zones the toughness will drop to make steel softened and brittle instead of getting softened and tougher, tempering is avoided at those low toughness zone so to get good hardness/toughness combination.

Some applications require different hardness/toughness combination, such as cutting tools, springs, spade, etc. In such cases, one can choose different tempering temperature to achieve the desired result. However, when tempering temperature goes up, hardness decreases, while the toughness does not increase but drops twice.

According to the present invention, to prevent decrease in toughness, the tempering temperature is fixed with best hardness/toughness combination and adjusting chemical composition (generally adjust Carbon content only). The advantage of this method is not only to get best hardness/toughness combination, but simplified tempering process since tempering temperature is fixed.

Furthermore, the present invention determines the effects of variations in alloy compositions, particularly carbon, on properties of alloys, including steel. In particular, the present invention provides a fixed tempering temperature to achieve the optimal hardness/toughness combination. Thus, the invention provides a method of increasing hardness of steel by tempering at peak toughness temperature only and by adjusting the chemical composition of selected elements to obtain different hardness of the steel and to achieve optimal hardness/toughness combination.

The peak toughness is determined by measuring the degree of hardness and toughness at various tempering temperatures and identifying the first peak of toughness.

The optimal hardness/toughness combination for the steel alloy is determined by variations in carbon compositions while maintaining the same peak toughness temperature during the tempering process.

The foregoing description of the embodiments has been provided for purposes of illustration and not intended to limit the scope of the present disclosure. Individual components of an embodiment are generally not limited to that embodiment but are interchangeable. Such variations are not to be regarded as a departure from the present disclosure, and all such modifications are considered to be within the scope of the present disclosure.

1. A method of increasing hardness of steel by tempering at peak toughness temperature only and by adjusting a steel composition consisting of:
Carbon: 0.15-1.50%; Silicon: 0.9-3.5%; Manganese: 1.0-4.0%; Chromium 0.6-5.0%; Molybdenum 0.05-0.60%; Vanadium 0.05-6.00%; Tungsten 0.05-10.00%; boron, Sulphur and Phosphorus in range between 0-0.04%, and remainder iron
to obtain different hardness of said steel and to achieve optimal hardness/toughness combination wherein
the chemical content of carbon is adjusted to ensure all materials are tempered at the same peak toughness temperature; there are two temperature zones and the toughness will drop to make steel softened and brittle instead of turning softened and tougher wherein tempering is avoided at those low toughness zone to enable good hardness/toughness combination.

2. The method according to claim 1 wherein peak toughness is determined by measuring the degree of hardness and toughness at various tempering temperatures and by identifying the first peak of toughness.

3. The method according to claim 1 wherein the optimal hardness/toughness combination is determined by variations in carbon compositions while maintaining the same peak toughness temperature during the tempering process and when used in agriculture and mining.

4. The method according to claim 3 wherein the tempering temperature is maintained at 190° C.

5. (canceled)

6. The method according to claim 1 wherein the steel composition comprises carbon up to 1.40% and silicon up to 3.00%.

7. (canceled)

8. The method according to claim 1 wherein the steel composition comprises molybdenum up to 0.50%.

9. The method according to claim 1 wherein the steel composition comprises vanadium up to 5.00% and tungsten up to 8.00%.

10. The method according to claim 1 wherein the steel composition comprises carbon up to 1.50%, silicon up to 3.40%, tungsten up to 6.00% and vanadium up to 5.00%.

11. The method according to claim 1 wherein the steel composition comprises carbon 0.2-0.3%, silicon 2.6-2.8%, manganese 2.0-2.3%, chromium 2.7-3.0%, molybdenum 0.15-0.25 and vanadium 0.40-0.70%.

12. The method according to claim 1 wherein the steel composition comprises carbon 0.3-0.4%, silicon 2.6-2.8%, manganese 2.0-3.0%, chromium 2.5-3.0%, molybdenum 0.3-0.5%, tungsten 6-8% and vanadium 0.20-0.40%.

13. The method according to claim 1 wherein the steel composition comprises carbon 1.50%, silicon 3.40%, tungsten 7.0% and vanadium 5.0%.

14. The method according to claim 1 wherein the chemical content of Carbon is adjusted to ensure all materials are tempered at the same peak toughness temperature; there are two temperature zones resulting in two peak tempering temperatures and the toughness will drop to make steel softened and brittle instead of getting softened and tougher wherein tempering is avoided at those low toughness zone to enable good hardness/toughness combination.

15. The method according to claim 14 wherein hardening temperature is in the range 820-980° C. and tempering temperature is in the range 150-550° C. and wherein the resulting product remains hardened after hard facing and tungsten carbide tile brazing.

16. (canceled)

17. A steel composition consisting of carbon 0.2-0.3%, silicon 2.6-2.8%, manganese 2.0-2.3%, chromium 2.7-3.0%, molybdenum 0.15-0.25 and vanadium 0.40-0.70%; B boron, S Sulphur and P in range between 0-0.04%, and remainder iron wherein the hardness of said steel is increased by tempering at a peak toughness constant temperature only.

18. A steel composition consisting of carbon 0.3-0.4%, silicon 2.6-2.8%, manganese 2.0-3.0%, chromium 2.5-3.0%, molybdenum 0.3-0.5%, tungsten 6-8% and vanadium 0.20-0.40%, B boron, S Sulphur and P in range between 0-0.04%, and remainder iron wherein the hardness of said steel is increased by tempering at a peak toughness constant temperature only.

19. The composition according to claim 17 wherein the chemical content of Carbon is adjusted to ensure all materials are tempered at the same peak toughness temperature; there are two temperature zones resulting in two peak tempering temperatures and the toughness will drop to make steel softened and brittle instead of turning softened and tougher wherein tempering is avoided at those low toughness zone to enable good hardness/toughness combination.

20. The composition according to claim 19 wherein when used in agriculture and mining, peak toughness is determined by measuring the degree of hardness and toughness at various tempering temperatures and identifying the first peak of toughness.

21. The composition according to claim 19 wherein the optimal hardness/toughness combination is determined by variations in carbon compositions while maintaining the same peak toughness temperature during the tempering process.

22. The composition according to claim 17 wherein hardening temperature is in the range 820-980° C. and tempering temperature is in the range 150-550° C.

23. The composition according to claim 22 wherein the tempering temperature is maintained at 190° C.

24. (canceled)
